(19) United States
(12) Patent Application Publication
(10) Pub. No.: US 2016/0146983 A1
(43) Pub. Date: May 26, 2016

(54) OPTICAL COLLAGE REFLECTARRAY

(71) Applicant: RAMOT AT TEL-AVIV UNIVERSITY LTD., Tel Aviv (IL)

(72) Inventors: Zeev ILUZ, Gan-Yavne (IL); Amir BOAG, Yavne (IL); Yael HANEIN, Caesarea (IL); Jacob SCHEUER, Tel Aviv (IL); Yuval YIFAT, Ramat Gan (IL); Michal EITAN-WIENER, Kfar-Saba (IL)

(21) Appl. No.: 14/905,808

(22) PCT Filed: Jul. 15, 2014
(86) PCT No.: PCT/IB2014/063107

§ 371 Date: Jan. 17, 2016

Related U.S. Application Data
(60) Provisional application No. 61/846,631, filed on Jul. 16, 2013.

(51) Int. Cl. G02B 5/09

(52) U.S. Cl. CPC G02B 5/09

(57) ABSTRACT

A reflectarray for shaping electromagnetic radiation having a characteristic wavelength in an operating band of wavelengths, the reflectarray comprising: a planar backplane that reflects the electromagnetic radiation; a dielectric layer located on the backplane; a plurality of cells, each cell characterized by a maximum dimension less than the characteristic wavelength of the radiation and comprising an array of at least two antennas having different shapes that reflect the electromagnetic radiation; wherein the antennas in the plurality of cells are coplanar.

### RELATED APPLICATIONS

The present application claims the benefit under 35 U.S.C. 119(e) of U.S. Provisional Application 61/846,631 filed on 16 Jul. 2013, the disclosure of which is incorporated herein by reference.

### FIELD

Embodiments of the invention relate to arrays, referred to as “reflectarrays”, of antennas configured to reflect incident electromagnetic radiation into a desired pattern of reflected radiation.

### BACKGROUND

A reflectarray typically comprises an array of a large number of small antennas that reflects incident electromagnetic radiation in a selected operating wavelength band into a beam of reflected radiation having a desired structure. The antennas are typically mounted on or in a planar layer of a dielectric material backed by a reflective “backplane”. Each of the antennas and its immediate neighborhood regions of dielectric material and backplane are conventionally referred to as a “unit cell” or “cell” of the reflectarray, and each unit cell is configured to reflect the incident electromagnetic radiation with a particular associated phase shift, hereinafter also referred to as the unit cell's phase, so that interference of the radiation reflected by the cells generates the desired beam.

The antennas in a reflectarray typically have a similar shape and are relatively small in the sense that they are characterized by maximum dimensions that are less than a characteristic wavelength of the reflectarray operating wavelength band. Advantageously, the maximum dimensions of the antennas and the pitch of the cells comprising the antennas in the reflectarray are less than or equal to about one half the wavelength characteristic of the operating wavelength band for which the reflectarray is designed.

A phase with which a given cell in a reflectarray reflects electromagnetic radiation in the selected wavelength band that is incident on the cell may be determined by the pitch of the cells in the array, the characteristic size of the antenna the cell comprises, distance of the antenna from the reflective backplane, the dielectric constants, and/or the conductivities of the antennas and the materials in the cell. Generally, phase shifts that cells in a reflectarray impart to reflected radiation are controlled by controlling antenna geometry. To provide a desired reflected beam, it may be required to provide a reflectarray with cells that impart phase to reflected radiation in a large, 360°, phase range. An operating wavelength band for which the reflectarray provides satisfactory performance is generally narrow because the phases with which the cells in the reflectarray reflect incident radiation are relatively sensitive to the wavelength of the radiation.

Reliable, commercially available reflectarrays for microwaves (wavelengths in a range from about 10 cm to about 1 cm) and millimeter (wavelengths from about 10 mm to about 1 mm) waves are known and have been used for example in satellite communications and to provide fixed focus and contoured beams of radiation. For example, planar reflectarrays that operate as parabolic reflectors for microwave and millimeter wave radiation are commercially available.

However, as the wavelengths of operating frequency bands for which reflectarrays are intended for use decrease, and the pitches and sizes of their cells and antennas decrease, manufacturing tolerances for their production become more stringent and difficult to meet. In addition, as the sizes and pitches of the cells and antennas in a reflectarray array decrease, the reflectarray becomes more susceptible to physical distortion caused by changes, such as changes in temperature and humidity, in an ambient environment in which the reflectarray operates. The changes may generate changes in cell phases that result in concomitant degradation in functioning of the reflectarray.

### SUMMARY

An aspect of an embodiment of the invention relates to providing a reflectarray comprising an array of unit cells that may readily be adjusted to provide desired phases in a relatively large range of phases that are relatively insensitive to changes in dimensions of features of the unit cells, which may be generated by changes in ambient environment. The large range of phases may be substantially equal to 360°. Optionally, the reflectarray is configured for use at optical wavelengths. Optical wavelengths are understood to include the near ultraviolet (UV), visible, and near infrared (IR) portions of the electromagnetic spectrum and include wavelengths in a band of wavelengths from about 200 nm (nanometers) to about 12 μm (micrometers).

In an embodiment of the invention, each of a plurality of the unit cells comprises a collage of antennas that are substantially coplanar and have different shapes. In an embodiment, substantially all the antennas in the reflectarray are substantially coplanar, advantageously enabling the reflectarray to be manufactured by printing. A reflectarray in accordance with an embodiment having unit cells comprising a collage of different shaped antennas may be referred to as a collage reflectarray. A unit cell of a collage reflectarray may be referred to as a collage cell.

In the discussion, unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended. Unless otherwise indicated, the word “or” in the description and claims is considered to be the inclusive “or” rather than the exclusive or, and indicates at least one of, or any combination of items it conjoins.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical features that appear in more than one figure are generally labeled with a same label in all the figures in which they appear. A label labeling an icon representing a given feature of an embodiment of the invention in a figure may be used to reference the given feature. Dimensions of features shown in the figures are chosen for convenience and clarity of presentation and are not necessarily shown to scale.

FIGS. 1A and 1B schematically show collage reflectarray cells comprising a collage of different shaped antennas in accordance with an embodiment of the invention;

FIG. 2 schematically shows a collage reflectarray comprising collage reflectarray cells similar to the collage reflectarray cells shown in FIGS. 1A and 1B, in accordance with an embodiment of the invention;

FIG. 3 shows graphs of phase and attenuation that a reflectarray cell similar to a reflectarray cell shown in FIGS. 1A and 1B produces in IR (infrared) light having wavelength equal to about 1.545 μm, in accordance with an embodiment of the invention;

FIG. 4 schematically shows a collage reflectarray configured to operate as a parabolic mirror for light, in accordance with an embodiment of the invention; and

FIGS. 5A-5E schematically shows various configurations of collage unit cells in accordance with embodiments of the invention.

### DETAILED DESCRIPTION

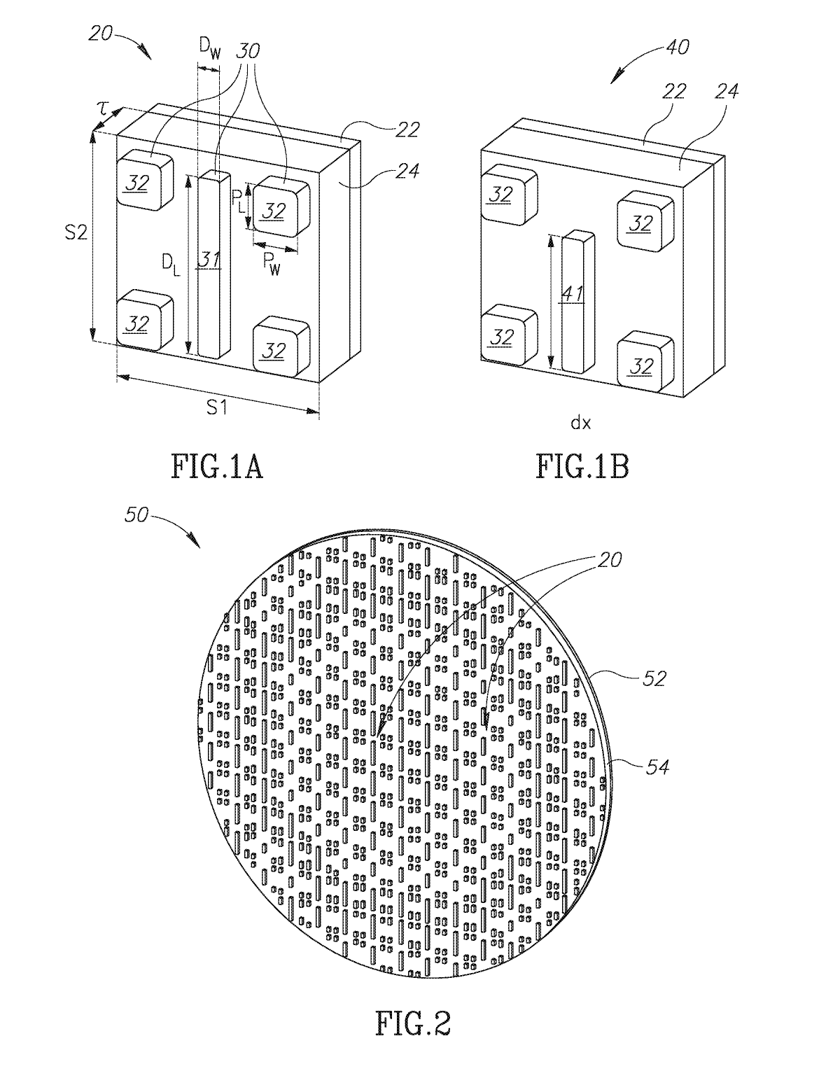

FIG. 1A schematically shows a unit collage unit cell 20 for use as a unit cell in a collage antenna designed, in accordance with an embodiment of the invention, to reflect and configure incident electromagnetic radiation. Optionally the incident electromagnetic radiation is characterized by wavelengths in an optical operating bandwidth having FWHM (full width at half maximum) equal to about 10% of a central wavelength in the operating bandwidth.

Cell 20 comprises a backplane 22, a dielectric layer 24, and a plurality of optionally five antennas generically labeled and referred to by a reference numeral 30. Antennas 30 optionally comprise a dipole antenna 31 and four “patch” antennas 32, which may be referred to as “patches 32”. Cell 20 has sides having lengths S1 and S2, and dielectric layer 24 has thickness, τ. Dipole antenna 31 has length D_{L} and width D_{W}. Patches 32 have lengths and widths “P_{L}” and “P_{W}” respectively.

A phase that unit cell 20 imparts to electromagnetic radiation incident on the unit cell may be controlled by controlling a dimension, for example D_{L}, D_{W}, P_{L}, or P_{W}, of at least one of antennas 30. By way of example, a collage unit cell 40 in accordance with an embodiment of the invention schematically shown in FIG. 1B is optionally identical to unit cell 20 except that unit cell 40 has a dipole antenna 41 that is shorter than dipole antenna 31 in unit cell 20. The shorter dipole antenna 41 configures unit cell 40 to impart a different phase to incident light than a phase imparted to incident light by unit cell 20.

Hereinafter collage unit cells in accordance with an embodiment of the invention that are similar to cell 20 except for dimensions of antennas 30 are referred to as collage cells 20. Variation in phase that a collage cell 20 provides as a function of a change in a dimension of a feature of the cell is discussed below.

An optionally circular collage reflectarray 50 comprising collage unit cells 20 formed on a common conductive backplane 52 and dielectric layer 54 is schematically shown in FIG. 2. Except for lateral extent, backplane 52 and dielectric layer 54 may be identical to dielectric layer 22 and backplane 24 respectively, shown in FIGS. 1A and 1B. Collage reflectarray 50 may be configured to reflect incident light, optionally in an optical, operating wavelength band into a reflected beam having a desired direction of propagation and/or structure by suitably adjusting phases of the component collage unit cells 20.

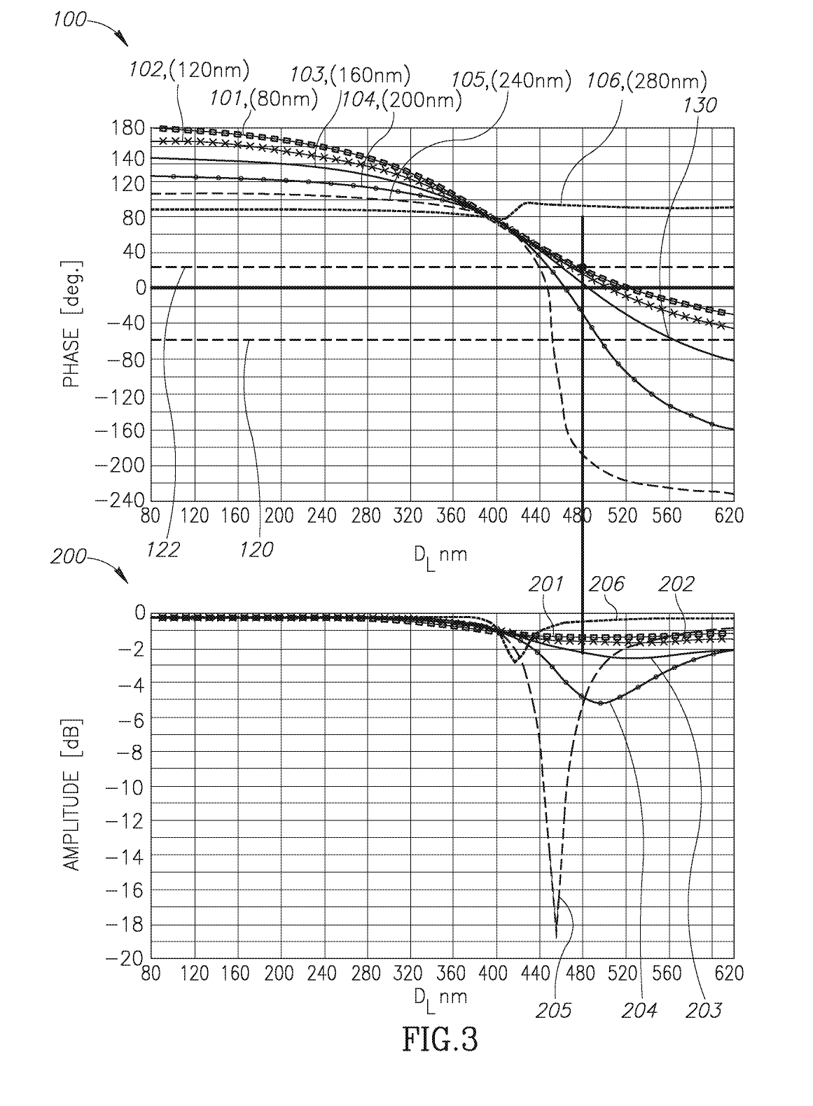

In an embodiment of the invention, phases provided by collage unit cells 20 are determined by adjusting lengths D_{L} (FIG. 1A) of dipole antennas 31 and sizes of patches 32 comprised in the unit cells assuming that patch length P_{L} is equal to patch width P_{W}. A phase graph 100 shown in FIG. 3 exhibits curves 101, 102, 103, 104, 105, and 106 that show change in phase Φ(D_{L}, P_{W}) as a function of length D_{L} of dipole antenna 31 and width P_{W} of patches 32 that a unit cell 20 generates in IR light having wavelength 1.545 μm that is incident on and reflected by the unit cell. Antennas 30 are optionally made from gold and are about 80 nm thick. Dielectric layer 54 is optionally a monolithic layer having thickness τ (FIG. 1A) equal to about 240 nm an index of refraction equal to about 1.527 and made from Quartz. Each curve shows change in phase as a function of D_{L} for a different constant patch width P_{W}. Curves 101, 102, 103, 104, 105, and 106 respectively show phase Φ(D_{L}, P_{W}) for values of P_{W} equal respectively to 80 nm, 120 nm, 160 nm, 200 nm, 240 nm, and 280 nm.

An attenuation graph 200 in FIG. 3 shows curves 201, 202, 203, 204, 205, and 206 of attenuation of the IR light reflected by unit cells 20 as a function of dipole length D_{L} and patch width P_{W} for the same patch widths and range of dipole lengths shown in phase graph 100. Attenuation curves 201, 202, 203, 204, 205, and 206 correspond to phase curves 101, 102, 103, 104, 105, and 106, respectively. For a given cell phase determined by a dipole length and patch width shown by a curve 101, 102, 103, 104, 105, and 106, an amount by which the cell attenuates IR light that the cell reflects is given by curves 201, 202, 203, 204, 205, and 206, respectively.

From graphs 100 and 200 it is readily seen that a collage unit cell 20 can be adjusted to provide substantially any phase in a 360° range of phases by adjusting the length D_{L} of its dipole antenna 31 and width P_{W} of its patches 32. Furthermore it may be seen from the graphs that for a given desired phase, more than one variation of collage unit cell 20 is available to provide a desired phase. And, that in general, for a give desired phase, a cell configuration for collage unit cell 20 can be chosen for which change in phase as a function of dipole length, indicated by slope of a curve 101, 102, 103, 104, 105, or 106, at the desired phase is relatively moderate. As a result, not only can a collage unit cell 20 be configured to provide a desired phase in a relatively large range of phases, but the collage cell may be configured so that sensitivity of the desired phase to changes in dimensions of features in the collage cell caused by changes in ambient environment are relatively moderate.

By way of example, assume that a unit cell phase of −60° is desired. A horizontal indicator line 120 at −60° in phase graph 100 indicates that a collage cell 20 in accordance with an embodiment of the invention, having a dipole length D_{L} greater than about 460 nm and a patch width P_{W} greater than or equal to about 160 nm and possibly greater than or equal to about 120 nm should be able to provide the desired phase. Indicator line 120 intersects phase curve 103 in an intersection region 122 at a dipole length D_{L} equal to about 570 nm, and at the intersection region phase curve 130 has a relatively moderate slope. The intersection region therefore indicates that a collage cell 20 in accordance with an embodiment of the invention having a dipole length D_{L} equal to about 570 nm and patch width P_{W} equal to about 160 nm would provide the desired phase and that the phase would be relatively stable in the face of environmental change. The attenuation curve 203 shown in graph 200 that corresponds to phase curve 103 shows that attenuation of IR light by the cell for the dipole antenna length D_{L} would also be relatively mild. A collage cell 20 having dipole length equal to about 570 nm and patch width equal to about 160 nm would therefore be a relatively good choice for providing the desired phase.

Similarly, an indicator line 122 indicates that a collage unit cell 20 in accordance with an embodiment of the invention having a dipole length D_{L} equal to about 480 nm and patch width P_{W} equal to about 80 nm would be a reasonable choice for a collage unit cell 20 required to provide a phase equal to about 25°.

It is noted that whereas reflectarray 20 was indicated as having antennas made from gold and a monolith dielectric layer made from quartz, embodiments of the invention are not limited to gold antenna or monolithic dielectric layers formed from quartz. Any of various suitable materials that reflect electromagnetic waves in a desired operating wavelength band may be used to provide antennas. By way of example, antennas 30 may be formed from metals other than gold, graphene, or polysilicon. Dielectric layer 54 may be a composite layer comprising component layers optionally having different indices of refraction. In an embodiment of the invention, each of a plurality of composite layers may comprise collage cells similar to collage cell 20, each comprising a plurality of different shaped antennas. Backplane 52 may be any suitable reflective material.

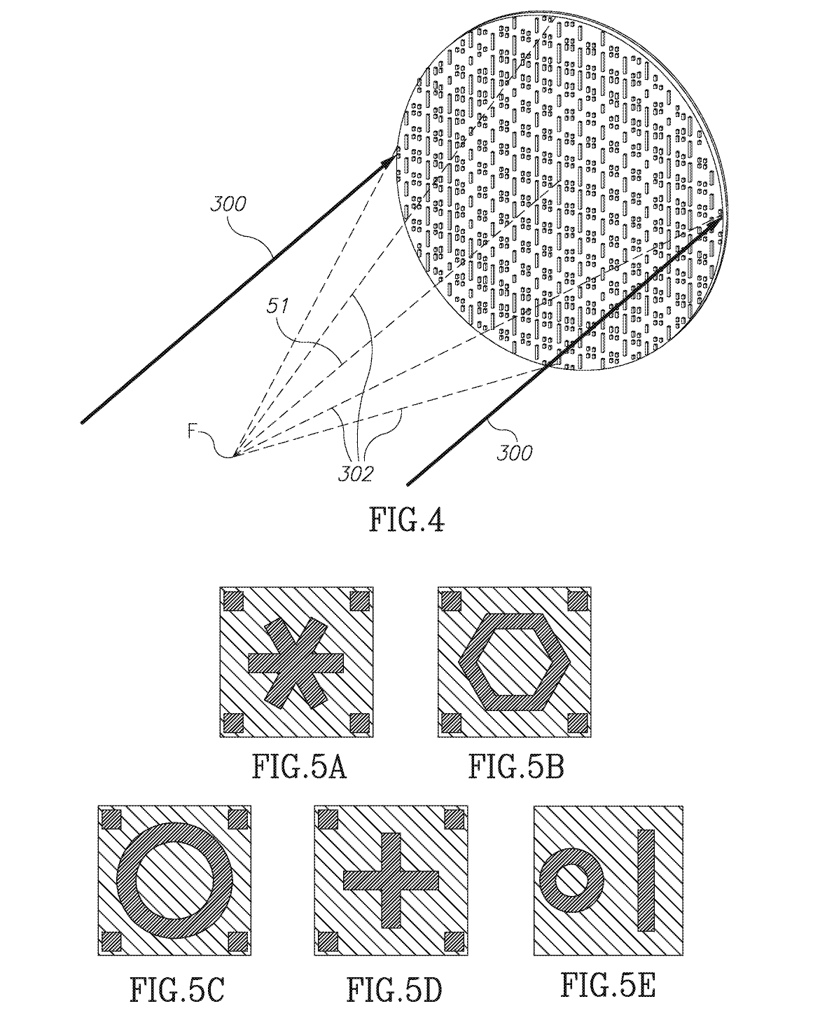

FIG. 4 schematically shows collage reflectarray 50 comprising collage unit cells 20 configured in accordance with an embodiment of the invention to function as a parabolic mirror/reflector that focuses IR light incident on the reflectarray parallel to an axis 51 of the reflectarray to a focal region “F”. Focal region F is located at a distance L_{F} from reflectarray 50. Light parallel to axis 51 incident on the reflectarray is represented by arrows 300. IR light reflected by reflectarray 50 from incident light 300 and focused to focal region F is represented by dashed lines 302.

Phases of collage cells 20 are chosen so that IR light 302 reflected by collage cells 20 reaches focal region F substantially in phase. Let rows and columns of collage unit cells 20 in collage reflectarray 50 be represented by indices i and j, and a collage cell at a junction of an i-th row and j-th column be represented by CC_{i,j}. Let a center of reflectarray 50 be located at an intersection of the 0-th row and 0-th column, and a collage unit cell 20 at the center of the reflectarray represented by CC_{O,O}. Let a path length from unit cell CC_{i,j} to focal region F be represented by L_{i,j}. A path length from CC_{O,O} to F is equal to the distance L_{F}.

IR light 302 from a collage cell CC_{i,j} reaches F with a phase lag Δφ(i,j) equal to 2π(L_{i,j}−L_{F})/λ, where λ is the wavelength of the IR light. To neutralize the phase lag so that IR light 302 reflected by collage unit cell CC_{i,j} and light reflected by collage unit cell CC_{O,O} reach F in phase, unit cell CC_{i,j} is configured to have a phase Φ(i,j)=[Δφ(i,j) mod 2π].

Representative phases Φ(i,j) for a simulated reflectarray 50 in accordance with an embodiment of the invention having a diameter D=10.8 μm, focal length F=5.76 μm and configured for IR light at wavelength λ equal to 1.545 μm are given in the following TABLE OF REPRESENTATIVE PHASES Φ(i,j) for the first 7 rows and 7 columns of the simulated reflectarray in an upper right hand quadrant of the reflectarray.

TABLE OF REPRESENTATIVE PHASES Φ(i, j)

| | Center | | | | | | | | |
|---|---|---|---|---|---|---|---|---|---|
| | column | | | | | | | | |
| j = 7 | 81.2° | 89° | 112.4° | | | | | | |
| j = 6 | 335.5° | 343.8° | 8.7° | 49.3° | 105° | | | | |
| j = 5 | 240.5° | 249.4° | 275.7° | 318.6° | 16.9° | 89° | | | |
| j = 4 | 158.4° | 167.7° | 195.4° | 240.5° | 301.6° | 16.9° | 105° | | |
| j = 3 | 91.2° | 101° | 130° | 177° | 240.5° | 318.6° | 49.3° | | |
| j = 2 | 41.3° | 51.4° | 81.4° | 130° | 195.4° | 275.7° | 8.7° | 112.4° | |
| j = 1 | 10.4° | 20.8° | 51.4° | 101° | 167.7° | 249.4° | 343.8° | 89° | |
| j = 0 | 0 | 10.4° | 41.3° | 91.2° | 158.4° | 240.5° | 335.5° | 81.2° | Center |
| | | | | | | | | | row |
| | i = 0 | i = 1 | i = 2 | i = 3 | i = 4 | i = 5 | i = 6 | i = 7 | |

The simulated reflectarray focused the IR light at F to generate a peak electric field that was about 65% of the peak electric field generated by a conventional parabolic IR mirror/reflector having a same focal length and diameter.

It is noted that whereas in the example of FIG. 4 reflectarray 50 is configured to operate as a parabolic mirror/reflector a reflectarray in accordance with an embodiment of the invention is not limited to focusing electromagnetic waves to a focal region. A reflectarray in accordance with an embodiment of the invention may be used to provide any of various desired electromagnetic wavefronts. For example a reflect array may be configured to shape a wavefront suitable for generating an optical beam that produces the batman logo at a desired distance from the reflectarray and desired angle relative to a normal to the reflectarray.

It is further noted that whereas the preceding discussion describes a collage reflectarray having collage unit cells comprising a single dipole antenna and symmetric configuration of satellite patch antennas, embodiments of the invention are not limited to the discussed configurations. By way of example, FIGS. 5A-5E schematically show other configurations of collage unit cells that may be used to provide reflectarrays in accordance with embodiments of the invention.

There is therefore provide in accordance with an embodiment of the invention a reflectarray for shaping electromagnetic radiation having a characteristic wavelength in an operating band of wavelengths, the reflectarray comprising: a planar backplane that reflects the electromagnetic radiation; a dielectric layer located on the backplane; a plurality of cells, each cell characterized by a maximum dimension less than the characteristic wavelength of the radiation and comprising an array of at least two antennas having different shapes that reflect the electromagnetic radiation; wherein the antennas in the plurality of cells are coplanar.

Optionally. the operating band of wavelength is an optical band of wavelengths. Additionally or alternatively the cells have a substantially same shape perimeter.

In an embodiment of the invention, the antennas are formed on a surface of the dielectric layer on a side of the dielectric layer opposite to a side of the dielectric layer on which the backplane is located. In an embodiment of the invention, the antennas are located in the dielectric layer.

In an embodiment of the invention, the antenna arrays in at least two cells of the plurality of cells exhibit at least one difference. Optionally, the at least one difference comprises a difference in size between an antenna in one of the two cells and an antenna of the other of the two cells. Additionally or alternatively, the at least one difference comprises a difference in shape between an antenna in one of the two cells and an antenna of the other of the two cells. The at least one difference may comprise a difference in a location of an antenna in one of the two cells and a location of an antenna in the other of the two cells relative to homologous points in the cells.

In an embodiment of the invention, each cell comprises at least one dipole antenna. In an embodiment of the invention, each cell comprises at least one patch antenna. In an embodiment of the invention, each cell comprises at least one annular antenna. Each cell may comprise at least one polygon shaped antenna.

In an embodiment of the invention, the characteristic wavelength is a near infrared (IR) wavelength. The characteristic wavelength may be less than or equal to about 2 μm.

In an embodiment of the invention, the characteristic wavelength is a visible wavelength.

In the description and claims of the present application, each of the verbs, “comprise”, “include” and “have”, and conjugates thereof, are used to indicate that the object or objects of the verb are not necessarily a complete listing of components, elements, or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A reflectarray for shaping electromagnetic radiation having a characteristic wavelength in an operating band of wavelengths, the reflectarray comprising:
a planar backplane that reflects the electromagnetic radiation;
a dielectric layer located on the backplane;
a plurality of cells, each cell characterized by a maximum dimension less than the characteristic wavelength of the radiation and comprising an array of at least two antennas having different shapes that reflect the electromagnetic radiation;
wherein the antennas in the plurality of cells are coplanar.

2. The reflectarray according to claim 1 wherein the operating band of wavelength is an optical band of wavelengths.

3. The reflectarray according to claim 1 wherein the cells have a substantially same shape perimeter.

4. The reflectarray according to claim 1 wherein the antennas are formed on a surface of the dielectric layer on a side of the dielectric layer opposite to a side of the dielectric layer on which the backplane is located.

5. The reflectarray according to claim 1 wherein the antennas are located in the dielectric layer.

6. The reflectarray according to claim 1 wherein the antenna arrays in at least two cells of the plurality of cells exhibit at least one difference.

7. The reflectarray according to claim 6 wherein the at least one difference comprises a difference in size between an antenna in one of the two cells and an antenna of the other of the two cells.

8. The reflectarray according to claim 6 wherein the at least one difference comprises a difference in shape between an antenna in one of the two cells and an antenna of the other of the two cells.

9. The reflectarray according to claim 6 wherein the at least one difference comprises a difference in a location of an antenna in one of the two cells and a location of an antenna in the other of the two cells relative to homologous points in the cells.

10. The reflectarray according to claim 1 wherein each cell comprises at least one dipole antenna.

11. The reflectarray according to claim 1 wherein each cell comprises at least one patch antenna.

12. The reflectarray according to claim 1 wherein each cell comprises at least one annular antenna.

13. The reflectarray according to claim 1 wherein each cell comprises at least one polygon shaped antenna.

14. The reflectarray according to claim 1 wherein the characteristic wavelength is a near infrared (IR) wavelength.

15. The reflectarray according to claim 14 wherein the characteristic wavelength is less than or equal to about 2 μm.

16. The reflectarray according to claim 1 wherein the characteristic wavelength is a visible wavelength.
